(19) United States
(12) Patent Application Publication
(10) Pub. No.: US 2024/0141516 A1
(43) Pub. Date: May 2, 2024

(54) MODULAR ELECTROCHEMICAL SYSTEM

(71) Applicant: Enapter S.r.l., Crespina Lorenzana (IT)

(72) Inventors: Holger EISENLOHR, Crespina Lorenzana (IT); Jan-Justus SCHMIDT, Crespina Lorenzana (IT); Ella Marijke VAN DER PUT, Crespina Lorenzana (IT); Kai LOUDON, Crespina Lorenzana (IT); Vito PINTO, Crespina Lorenzana (IT); Alessandro PERSICHETTI, Crespina Lorenzana (IT)

(21) Appl. No.: 18/550,930

(22) PCT Filed: Mar. 17, 2022
(86) PCT No.: PCT/EP2022/057014

§ 371 Date: Sep. 15, 2023

(30) Foreign Application Priority Data
Mar. 17, 2021 (GB) 2103709.8

(51) Int. Cl. C25B 9/77; C25B 1/04; C25B 9/19; C25B 9/65; C25B 15/025; C25B 15/027; C25B 15/031; C25B 15/033; C25B 15/08

(52) U.S. Cl. CPC C25B 9/77; C25B 1/04; C25B 9/19; C25B 9/65; C25B 15/025; C25B 15/027; C25B 15/031; C25B 15/033; C25B 15/087

(57) ABSTRACT

A containerised modular electrochemical cell system, comprising: a housing; and a plurality of electrochemical stacks removably mounted within said housing, each stack comprising: one or more electrochemical cells; one or more fluid inlet(s) for receiving feedstock; and one or more product outlet(s), wherein the stacks are arranged in at least one string, each string comprising two or more of the stacks, the stacks in each string being electrically connectable in series, and each string being connectable to a power source, and wherein each stack or string is configured to be independently activated; and wherein each string comprises: at least one feedstock inlet manifold fluidly coupled to the inlet(s) of the stacks of the string for distributing feedstock between the inlet(s) of the stacks, and at least one product outlet manifold fluidly coupled to the outlet(s) of the stacks of the string; and flow regulation means configured to regulate fluid flow through the inlet(s) and/or outlet(s).

### FIELD OF INVENTION

The present invention relates to a containerised system housing an array of modular electrochemical devices preferably, but not necessarily limited to electrolysers for the electrolytic production of hydrogen.

### BACKGROUND

Hydrogen has a multitude of applications, ranging from energy storage to the production of fertilisers. Hydrogen can be derived from many sources. Some of these sources, such as fossil fuels, are undesirable for obvious ecological and environmental reasons. Therefore, there is a need to be able to produce hydrogen in a reliable and sustainable manner.

Electrolysers are devices used for the generation of hydrogen and oxygen by, essentially, splitting water molecules. It is possible to power such devices with renewable energy, including utilising excess energy, so that hydrogen can be used as a means for energy storage, complementary to batteries, for example. Electrolysers generally fall into one of three main technologies currently available, namely anion exchange membrane (AEM), proton exchange membrane (PEM), and liquid alkaline systems. Liquid alkaline systems represent the most established technology, with PEM being somewhat less so. In contrast, AEM electrolysers are derived from a relatively new technology. Other technologies, such as solid oxide electrolysis are available, but they will not be discussed further herein.

AEM and PEM electrolysers are reliant on the transfer of ions from one half-cell to the other for the generation of hydrogen. AEM systems rely on the movement of hydroxide ions, OH⁻, whilst PEM systems rely on the movement of hydrogen ions, H⁺ through the membrane.

Other electrochemical devices include fuel cells, electrochemical compressors, or electrochemical purification devices. Each of these may be used alone, but can also be found to form part of a single hydrogen solution.

At present, it is common practice to size a single electrochemical stack for a required purpose. However, a common drawback for such activity is the required activation energy for each stack, especially of such a size, means that when less power is available the stack is not operated. The result is underutilization of available energy, and a reduced ability to respond to power fluctuations.

An object of aspects of the present invention is to provide an improved means and method for the housing and operation of modular electrochemical devices capable of utilising as much power as is available.

### SUMMARY OF THE INVENTION

According to one aspect disclosed herein, there is provided a containerised modular electrochemical cell system, comprising: a housing; and a plurality of electrochemical stacks removably mounted within said housing, each stack comprising: one or more electrochemical cells; one or more fluid inlet(s) for receiving feedstock; and one or more product outlet(s), wherein the stacks are arranged in at least one string, each string comprising two or more of the stacks, the stacks in each string being electrically connectable in series, and each string being connectable to a power source, and wherein each stack or string is configured to be independently activated; and wherein each string comprises: at least one feedstock inlet manifold fluidly coupled to the inlet(s) of the stacks of the string for distributing feedstock between the inlet(s) of the stacks, and at least one product outlet manifold fluidly coupled to the outlet(s) of the stacks of the string; and flow regulation means configured to regulate fluid flow through the inlet(s) and/or outlet(s).

According to another aspect disclosed herein there is provided a containerised modular electrochemical cell system, comprising:
a housing;
a plurality of electrochemical stacks removably mounted within said housing, each stack comprising one or more electrochemical cell, the one or more electrochemical cells being arranged in side-by-side relation to form said stack, wherein each stack comprises one or more fluid input(s) for receiving feedstock and one or more product output(s); wherein:
   two or more stacks form a string, the housing having therein one or more strings of stacks; and
   a power source operably connected to each string, wherein the stacks of each string are electrically connected in series;

wherein each string comprises at least one feedstock inlet fluidly coupled to the input(s) of the stack(s) thereof, and at least one product outlet fluidly coupled to each of the output(s) of the stack(s) thereof; the system further comprising
means for distributing feedstock between the feedstock inlets;
   flow regulation means disposed in said feedstock inlet and/or said outlet(s) of each stack, said flow regulation means being configured to selectively open and close the respective inlet(s) and/or outlet(s); and
computer-implemented power source control means for independently controlling the power supplied to each string of electrochemical cells.

As used herein, the term “fluid” preferably connotes both liquid (e.g. a liquid water or electrolyte stream) and gas (e.g. a hydrogen or oxygen gas stream).

Whilst it is envisaged that any electrochemical device may be used, in a preferred embodiment the electrochemical devices may be electrolysers. It will be understood by a person skilled in the art, however, that the required inlets and outlets would vary depending upon the nature of the electrochemical device.

In an exemplary embodiment, control means may be provided, communicably coupled to said feedstock delivery means, and configured to cause said feedstock delivery means to deliver quantities of feedstock to the inlet(s) dependent on available energy and/ power fluctuations. In an exemplary embodiment, means are provided for circulating spent electrolyte for reuse.

As used herein, “electrolytic stack” and “electrochemical stack” and “electrolyser” are intended to include reference to modular electrolysers, and electrolyser stacks and other modular electrochemical devices such as but not necessarily limited to compressors, purifiers, fuel cells or sensors.

As used herein, a modular device generally includes more subsidiary components than a stack itself. For embodiments of the present inventions wherein stacks are utilised, it is intended that more of the balance of plant (BoP) will be shared between devices.

As used herein feedstock generally refers to any input to the electrochemical cell. In embodiments using electrolysers this will generally be an electrolyte such as KOH for AEM electrolysers or deionised water for PEM. For embodiments with fuel cells this may be a predominantly hydrogen-based feed and a feed with significant amounts of oxygen. Electrochemical oxygen or hydrogen compressors will generally be fed with streams containing a substantial amount of either gas. The present invention is not necessarily intended to be limited by such parameters.

Whilst it is envisaged the housing may be a container, as used herein housing is intended to cover any arrangement including a baseplate upon which modules are located, or a general location. Said baseplate or equivalent may or may not include external walls and/or roof.

It is envisaged that the means for circulating feedstock may include, but is not necessarily limited to pumps, fans, or pressurised storage and associated valves for a regulated release. Circulating and distributing being used interchangeably, with circulating including embodiments wherein there is a closed loop for the electrolyte or equivalent used in embodiments with electrolysers.

Whilst it is envisaged that each string shares a power source, in the preferred embodiment the power source for within each string is in series. Alternatively, the power may be supplied to each stack withing a string in parallel. The strings themselves being supplied by distinct power supplies, parallel, or multiple in series. Regardless of power supply being in series or parallel, each stack is envisaged to have a front end or terminal and back end or terminal, the front end being adapted to receive either a positive or negative power supply and the back end having a negative or positive supply. In embodiments using fuel cells, where power is generated it is envisaged that each string supplies power with the power being provided in series by each stack in said string.

Fluid connections for the present invention are present for both inlets and outlets. The fluid connections may be supplied from a shared manifold and are also envisaged to be in series or in parallel. In the preferred embodiment parallel means for supply and removal of fluids are provided to ensure the requisite pressures are maintained.

Whilst it is envisaged that a variety of housings may be used, in the preferred embodiment a shipping container is used.

In the preferred embodiment, the flow regulating means are provided on the outlet, but may also or alternatively be provided on the or each inlet. Whilst it is envisaged any flow regulating means may be used, normally check or control valves are utilised.

In the preferred embodiment, the electrochemical stacks comprise at least an anodic and cathodic half-cell, preferably separated by a polymeric ion exchange membrane, more preferably still an anion exchange membrane. It is envisaged that the inlet will be for the introduction of a fuel, oxidant, water or equivalent. Such fluids can include any one or more of hydrogen, oxygen, methanol, methane, carbon dioxide, carbon monoxide or DI (deionised) water.

Whilst it is envisaged that each stack may be provided with its own power source forming a string of one electrochemical device, in the preferred embodiment a string comprises upwards of 2 electrochemical devices. Preferably a string has in the range of 2 and 20 electrochemical devices, more preferably still between 2 and 10 devices and yet even more preferably still between 4 and 6 electrochemical devices.

Whilst the feedstock may be discarded after use, in some embodiments, e.g. those using an electrolyser, the electrolyte or DI water feedstock is preferably recirculated, with means being provided for this.

Whilst it is possible for the present invention to be used with electrochemical devices of any size, preferably the power consumption is in the range of 1 kW-200 kW, more preferably still between 1 kW-100 kW, even more preferably still between 1 kW-20 kW, more preferably still between 1 kW-10 kW and more preferably still between 1.5 kW and 5 kW and even more preferably still between 2 kW and 3 kW. Devices at the smaller end of the spectrum allow for better utilisation of available power, and responses to power fluctuation. The ability to respond well to power fluctuations being desirable especially when the devices are intended for coupling to renewable energy sources.

It is envisaged that the system may have a total power consumption of between 0.5 MW and 200 MW, more preferably still substantially 1 MW or between 50 MW and 150 MW. In embodiments of the present invention wherein more MW are used, it may be more practical to use larger stacks, such as those in a 10 kW to 100 kW range in strings, or 50 kW to 500 kW or 50 kW to 250 kw or 100 kW to 200 kW.

Alternatively, it is envisaged that each stack has a power consumption that is a fraction of the overall system capacity such as between 1/100^{th} and 1/1000^{th}, or 1/50^{th} and 1/500^{th}, or 1/50^{th} and 1/1000^{th}. Preferably each stack will be between 1/200^{th} and 1/600^{th} or 1/50^{th} and 1/100^{th}. Normally the fraction is excluding the power requirements of the BOP.

In the preferred embodiment, the system is adapted to allow hot swapping of electrochemical components. Each string being provided with means enabling the electrical and fluid isolation of the string such as valves and switch(es) for controlling the power source. Once isolated, one or more stack in the isolated string can be replaced. This mitigates the need for down time, further improving the power utilisation of the system. It is further envisaged that stacks or strings not meeting expected performance characteristics, such as output values, may be adapted to be isolated by the computing means and a prompt sent indicating maintenance is required.

Whilst any type of electrochemical device may be used with the present invention, in the preferred embodiment the present invention is preferably coupled with AEM technology as opposed to PEM. More preferably still, when the electrochemical devices are electrolysers, AEM electrolysers with a substantially dry half cell, and more preferably still a dry cathode. A dry cathode, or anode, meaning a device where no electrolyte or equivalent is introduced to the cathodic, or anodic, half-cell.

Due to the nature of the required electrolyte, AEM devices are not reliant upon PGM catalysts, and also do not require materials resistant to the caustic conditions required by PEM devices.

Each string may be provided with a shared connection to the power source, or alternatively each device within said string may have its own device power source connection. In the preferred embodiment wherein more BOP is shared the power supply is in series and feedstock is in parallel via inlet manifold(s). Products of the process may be fluidly connected in parallel by outlet manifolds.

It is envisaged that strings of devices may be provided with means for temperature control, such means including but not necessarily limited to heat exchangers, air cooling, or liquid cooling. In the preferred embodiment, waste heat utilisation is employed using the heat emitted from the devices to preheat the electrolyte or other feedstock such as but not necessarily limited to water. Alternatively, waste heat may be utilised by providing heat to nearby housing, water or other industrial processes.

Whilst is it envisaged that the electrochemical cells may operate at a variety of temperatures in the preferred embodiment the temperature of the feedstock is not intended to surpass 100° C. More preferably still within the range of 40° C. and 80° C. and even more preferably still substantially 60° C. Preheating, and heat exchangers for waste heat utilisation may be employed to minimise energy waste.

In some embodiments using modules it is envisaged that means for ventilation or air cooling will be provided to the or to each module. However, this is not present for variants using stacks. In any case, even in variants wherein modules have means for ventilation, ventilation is preferably provided for the housing as a whole. Ventilation is provided to ensure that the ratio of hydrogen and oxygen does not pass the potentially hazardous levels.

Alternatively, in the preferred embodiment, ventilation means are provided for the system as a whole in the housing said ventilation being preferably controlled by the computing means, said computing means having one or more hydrogen sensors situated within the housing. By default, the ventilation means are quiescent which beneficially does not dilute any potential leak allowing the hydrogen sensors detect a leak more rapidly, and accurately. Location may be determined by using a plurality of sensors. If hydrogen is detected, the computing means are adapted to activate the ventilation means. This has the added benefit of maintaining the temperature within the housing, drastically reducing waste heat. Therefore, in the preferred embodiment it is desired that the means for ventilation is adapted to handle in the range of 10x-1000x the hydrogen produced, more preferably still between 25x and 200x, more preferably still 50x and 150x and even more preferably still substantially 100x.

In other embodiments using fuel cells or compressors as the electrolytic stack the ventilation means may be sized in accordance with the input of hydrogen or other feedstock in the ranges disclosed above

In embodiments where modules are used, said modules comprising a housing, the housing may further act as insulation preventing the entire container from reaching the temperature of the stack, rendering the system more readily serviceable without the need for ventilation.

The ventilation means may be further controlled by automated readings from alternative sensors, such as the computer means triggering ventilation when an unexpected pressure drop is measured on a fluid pipeline.

As a further means for safety measurement, the preferred embodiment comprises at least one sensor for hydrogen, and/or other gas(es) which may pose a safety concern. Whilst one sensor may be sufficient, the size of the housing may be sufficiently large that a plurality of sensors is desired, placed throughout the stack or housing. Said sensors may be passive, such as visual colour changing tape, however, in the preferred embodiment the sensors are adapted to trigger an alarm and preferably increase the ventilation flowrate before potentially hazardous levels are reached to minimise risk. Other means such as a mobile sensor may be used to detect a leak alone, or in combination with pressure readings from sensors placed on each stack or string, a drop in pressure being indicative of a leak.

In one embodiment of the present invention electrochemical hydrogen sensors may be employed in each column of stacked cells, or each string. Due to the nature of hydrogen gas, sensors are preferably placed substantially at the top of the housing, at least in the upper half. This is not intended to exclude sensors in the bottom half.

The computing means is intended to be controllably connected to the power supply for each device, or string thereof. In a preferred embodiment of the present invention, the computing means is also operably connected to any one or more sensors, for each device or string thereof, sensors including but not limited to: leak detectors, pressure sensors, temperature sensors, humidity sensors, flowrate sensors, level sensors, pH sensors, conductivity sensors, oxygen sensors, hydrogen sensors, electrolyte sensor, gas sensors for other feedstock such as but not limited to carbon monoxide.

The operable connection may be wired, or wireless such as by WiFi or Bluetooth®. It is envisaged that readings from the sensors may be rendered available to a user by another computing device, with access being secured by known means.

Whilst it is envisaged that a variety of power sources may be utilised, such as from a national grid, in the preferred embodiment energy is utilised from renewable sources, and more preferably excess renewable sources. Renewable sources include but are not limited to, solar, wind — onshore or offshore, tidal, hydro or a combination thereof. It has been found that AEM electrolysers are particularly well suited to cycling compared to other relatively established electrochemical processes.

It is envisaged that means may be provided for the treatment of spent electrolyte or feedstock for reuse in the system.

It is envisaged that one or more rectifiers may be used to convert incoming power such that it may be supplied as AC, DC or reverse pulse. The same applies for power output for embodiments of the present invention utilising fuel cells. The modular nature of the present invention renders it better suited to any known or employed technology for the utilisation of as much power as possible. To allow for this, strings of varying lengths may be provided in a single housing to allow for a more tailored control by the computing means. Strings of fewer devices being better suited to address fluctuations in loads. Strings with more units have a longer response time but can act as a buffer for larger fluctuations in energy supply more efficiently, due to better amplitude matching but decreased frequency matching. Shorter strings allow for faster response times, but decreased buffer capacity, due to better frequency matching and lower amplitude matching ability.

In embodiments of the present invention wherein the electrolytic stacks are fuel cells, the strings may be more responsive to required energy demands from the loads drawing on the system. The same may be applied to compressors as well.

In accordance with the present invention, it is envisaged that a variety of electrochemical devices may be housed together to form a hydrogen battery. The electrochemical devices in such a variant would include at least electrolysers and fuel cells. Electrochemical compressors may also be provided, or more traditional mechanical compressors. More preferably still AEM electrochemical compressors would be used to allow for the simultaneous compression, drying and/or purification of the produced hydrogen. BOP such as power supply and computing means may be shared between each type of electrolytic device. In order to function as a hydrogen battery, preferably storage means are provided within the housing.

In embodiments utilising electrochemical compressors, it is possible to compress either Hydrogen or Oxygen. Said compression may occur with optional purification. Hydrogen is preferably derived from a green source, such as water electrolysis, but a feed stock may be from a steam reformation or other non-renewable source of hydrogen, wherein simultaneous purification is certainly preferred. Where oxygen is to be compressed it may be derived from the outlet of one or more electrolysers, housed within the container or equivalent, or stripped from atmospheric air. The simultaneous purification can allow for medical or industrial use. However, means for drying may also be required prior to storage.

In lieu of fuel cells, such a hydrogen battery could be coupled to a refuelling station, or industrial process for the in-situ creation of required fuel stock.

It is envisaged that the layout of the housing will have the devices arranged in columns and rows. In embodiments utilising more than one type of electrochemical device, each group will preferably be situated in close proximity to devices of a similar type. For ease of access, it is envisaged that the devices will be situated allowing for three walkways, a central walkway between two walls of devices, said walls comprising a plurality of stacks. Additional walkways are envisaged to the rear of each wall, as shown in the figures. Alternatively, in order to save space, a central walkway only will be provided, with means for accessing the rear of stack modules including access doors/removable walls behind the stacks, or rendering the array of stacks moveable, such as by guide rails.

In a preferred embodiment, the walkway incudes a raised platform allowing for a clearance between 1 cm and 20 cm, or more preferably between 3 and 15 cm between the floor of the housing and the walkway platform upon which the stacks are mounted to allow for a clearance in which some BOP may be placed, and optional drainage for any condensation or other liquid to collect, and optionally air inlets. In such embodiments, drainage means may also be provided.

Additionally, it is envisaged that the walkway may be electrically insulated from the housing either by material selection, coating or other suitable means. The walkway may be the same or different material to the chassis of each stack, module or device.

Whilst it is envisaged that each module or stack may be provided with all of the required BOP, in the preferred embodiment BOP is shared as much as possible. This includes, but is not necessarily limited to power supply, water purification/feedstock treatment, feedstock circulation/distribution, sensors as described above, pressure regulating means, HVAC/ventilation means, safety system, product treatment.

In order to allow for the handling of large power supplies, it is envisaged that at least 10 of such modules will be used, but preferably over 20. For larger scales over it is envisaged a single container may house between 100 and 1000 modular devices, more preferably between 200 and 500 modular devices and more preferably still between 300 and 450 modular devices.

It is envisaged that the pressure regulating means on the outlet from the or each device are adapted to maintain a pre-determined threshold. This may vary depending on the device, but for the preferred embodiment wherein the electrochemical devices are electrolysers, the preferred pressure rating is between 1 and 50 bar, more preferably between 20 and 40 bar, and more preferably between 30 and 40 bar. In the most preferred embodiment it is substantially 35 bar. This may be limited to lower pressures in certain jurisdictions, such as 8 bar in Japan. Fuel cells may require considerably lower regulating means, whereas electrochemical compressors will naturally have higher means, normally in steps. An electrochemical compressor may eventually compress the target gas up to 2000 bar, or anywhere in the range of 30 bar to 2000 bar, 100 bar to 1500 bar or 500 bar to 1000 bar. In line with end usage for vehicles 350 bar, or 750 bar may be desired.

In embodiments using electrochemical compressors, each string may form a single stage, with a first stage feeding a second stage from P1 to P2 and so on to a final nth stage of Pn.

It is envisaged that the present invention may include means for electrically insulating or optionally fluidly isolating each stack from other stacks, strings of stack and or the optional chassis for each stack. The insulation may be provided by any reasonable means including electrically insulating materials or isolation can be done intermittently by adding circuit breakers, switches, and/or relays. It is envisaged that the means for intermittent isolation may be operably connected to computing means within the housing, or manually controlled/overridden, this includes flow regulation means disposed on said feedstock inlet and/or said outlet(s) of each stack, said flow regulation means being configured to selectively open and close the respective inlet(s) and/or outlet(s), as well as electrical connections.

Each stack or string thereof may be held within a chassis, said chassis comprising some BoP such as, but not necessarily limited to sensors (pressure, temperature etc.), electronics compartments, check valves and more. Additionally, ports may be provided for the inlet(s) and outlet(s). Furthermore, the chassis may also be provided with reinforcing support brackets, and compression means, said compression means being a spring or equivalent suspension to ensure sealing remains constant within the stack for its life span. Alternatively it is envisaged that the chassis may house more than one stack, such as 2 or more, a string of stacks or even multiple strings.

It is also envisaged that means for in-situ diagnostics may also be provided, said in-situ diagnostics being provided on a single device, or string of such devices, or a block of strings. A block of strings being two or more strings. Such diagnostics may be used to alert the user of required maintenance, pre-emptive or otherwise. Preferably the in-situ diagnostics may be used by the computing means to control the load distribution of the power supply to prioritise stacks with a better state of health (SoH). SoH may be determined using actual output compared to theoretical output and runtime of the devices.

In a preferred embodiment the in-situ diagnostics are coupled to the computing means and used to determine one or both of: power supply to the stack or string thereof, and how much feedstock should be made available to the stack or string thereof.

It is envisaged that means for determining in-situ diagnostics may include the ability to measure any one or more of the following:
cumulative run time of a stack or string thereof;
cumulative down time of a stack or string thereof;
operating capacity at which a stack or string thereof has been run at whilst running;
temperature of a stack or string thereof,
pressure of a stack or string thereof, and their associated inlets and or outlets,
voltage/potential of a stack or string thereof; and
data pertaining to the balance of plant such as but not limited to:
   feedstock flow,
   feedstock availability,
   Feedstock temperature
   conductivity or equivalent parameter of feedstock
   pump performance.

The above list is not necessarily exhaustive, any reasonable performance or operating condition from which the status of a component may be determined or inferred may be used, in addition or alternatively.

It is envisaged that, based on the previously mentioned monitored operating conditions, inputs and outputs, means are provided to predict outputs extrapolated from the previous operating conditions. This would allow the overall system to operate at a desired capacity or requirement. Where appropriate, such measurements may be taken at pre-determined intervals by the in-situ diagnostic means, which may optionally be altered by the user. Additionally, triggers may be given for the instigation of diagnostics. Such triggers could be a change of power supply, forecast change of conditions or any other conceivable trigger.

It is envisaged that the above information may be used by a control system or computing means according to an aspect of the invention to determine a “weighted run time” (WRT) for each device or string thereof, the WRT taking into account factors such as, but not limited to run time, power supplied whilst running, anticipated vs actual measured performance and down time.

There are a variety of ways in which the WRT may be used to control the operation of the system as a whole. Priority may be given to the device or string with the lowest WRT, however it may be preferable to prioritise another device or string depending on the State of Health (SoH), which may be determined by the in-situ diagnostics, should the in-situ diagnostics show or indicate an issue with a device having a lower WRT than other devices. This may be supplemented by polarisation curve measurements or other diagnostic techniques. A device may have reduced priority even with a lower WRT if in need of maintenance, or a potential issue has been detected.

Other methods of determining a stack's SoH, a supplement or alternative to the WRT, generally include fitting the stack to an equivalent circuit model. In the simplest cases said model including resistor and capacitor components, but generally also adapted to include mass transport contributions as well. An example being Randles circuit, which includes a Warburg element to represent mass transport effects. Additionally, constant phase elements, a more general kind of capacitor element, to reflect porous electrodes may be included.

Equivalent circuit fitting of impedance spectra is possible for electrochemical stacks, but to obtain more useful data it is envisaged that fitting such a stack to equivalent circuits either requires electrochemical impedance spectroscopy (EIS) or another circuit through which the stack can passively charge/discharge. The passive charge/discharge circuitry having requisite switches and resistors to allow passive charging and discharging of the stack. Upon charging and discharging, the resulting voltage transience can be used, with a sufficient sampling rate, wherein said sampling rate is pre-determined, to fit the stack to an equivalent circuit. For the avoidance of doubt, the measured voltage transience may be combined with means for using said transience for fitting pre-determined equivalent circuit parameters. Characteristics of the stack voltage transience can be directly correlated with performance parameters that need to be identified (i.e. ohmic resistance, kinetic activity characteristics, and even mass transport/low frequency behaviour). This arguably increases the hardware complexity but allows for specific determination of parameters associated with individual cell components. EIS generally requires potentiostats which are expensive, however, one such potentiostat may be used to a plurality of electrolysers or strings of electrolysers. A DC bias is applied to the stack with an AC component (+/−1% of the DC bias) such that the frequency of the AC perturbation is swept from kHz to mHz—the impedance is measured at each frequency and this data can be used to fit the stack to an equivalent circuit model. If using a potentiostat, it would be connected to the electrochemical cell, stack or string by known means not described herein.

The ideal case, simplifying the hardware requirements while still obtaining useful information, involves simply looking at the changes in polarization curve data where the below equation separates the three dominating sources of losses: kinetic, ohmic, and mass transport.

$$V = {\underbrace{E}}_{OCV} - {\underbrace{b log ( \frac{i}{{i}_{0}} )}}_{Kinetic} - {\underbrace{i {R}^{′}}}_{Ohmic} + {\underbrace{a log ( 1 - \frac{i}{{i}_{lim}} )}}_{Transport}$$

In this equation:
V is the measured stack voltage transience;
E is the open-circuit voltage (i.e. the electromotive force);

$$b log \frac{i}{{i}_{0}}$$

is the Tafel equation, representing kinetic losses, where:
   i is the applied current density;
   i₀ is the exchange current density; and
   b is a fitting coefficient, the “Tafel slope”
iR′ represents the ohmic losses, where:
   o i is the applied current density; and
   R′ is the DC resistance

$$a log ( 1 - \frac{i}{{i}_{l im}} )$$

represents the transport losses, where:
a is a fitting coefficient;
i is the applied current density; and
iₗᵢₘ is the limiting current density.

Yet another diagnostic method includes measuring ΔV, or the change of polarization curve diagnostic. The polarization curve, or voltage versus applied current graph, gives information of the different kinds of efficiency losses in an electrolyser cell/stack — kinetic, ohmic, and mass transport. Nominally, electrolysers are dominated by kinetic and ohmic losses, the former being a logarithmic V vs I relationship, and the latter being linear between V and I. Though mass transport losses are present in the worst cases, generally it can be taken as the difference between the raw polarization curve data and the kinetic+ohmic fitting data. The kinetic part having two fitting coefficients, these being Tafel slope and exchange current density, which are dependent on the electrochemical reactions of the cell and reflect the state of health of each electrode's catalyst layer. The ohmic part only has one fitting coefficient, this being DC resistance, factors impacting this including membrane state of health and increasing contact resistance due to corrosion. Lastly, mass transport generally has two fitting coefficients, a logarithm prefactor, and the limiting current density, both of which give us an idea of the degree of “resistance” of water getting to the catalyst layer and/or gases leaving the electrodes — mass transport losses mainly arise from the gas diffusion layer (GDL), catalyst layer, and/or the membrane.

Consider that nonlinear curve fitting with five free parameters is practically rather difficult in the presently described invention and there are time constraints if done too regularly, although improved processing power may go some way to mitigating this—with an associated cost. Ignoring mass transport fitting now and focusing on the kinetic and ohmic losses allows for simplification. For the fitting procedure and improving accuracy and stability, the ohmic part may be measured and fixed such that the nonlinear curve fitting is only correcting for the two kinetic parameters in the first and only logarithmic term. In embodiments wherein one of the fitting parameters is stable, say the Tafel slope, this may be set at a fixed point in the control software/methodology reducing the variable. However, it is preferred to fix something that can be measured quickly such as the DC resistance or other suitable parameter. Deviation from the fitted polarization curve of purely ohmic+kinetic contributions with respect to the measured values can be attributed to mass transport limitation onset, which can also be used to properly define a maximum capacity value.

Some methods for measuring the ohmic part mentioned above include EIS or current interrupt which require a potentiostat or an impedance meter to read the impedance at a fixed high frequency (e.g. 1 kHz). As mentioned before a single potentiostat may be centralized and used for multiple stacks or strings thereof. It should be noted that distinguishing between a logarithm and a linear part of a curve is not easily done if there is not enough data, this is normally more pronounced especially at a very low current density which requires a long time to remove the capacitive contribution. It is envisaged that the means may be adapted to conduct more measurements at lower current densities to ensure adequate data, lower current densities being half or less than maximum operating capacity. Measuring the resistance by direct methods (e.g. EIS, current interrupt, impedance meter) removes this numerical issue allowing for a fast recording of the polarization curve, requiring less points for an accurate numerical fitting regardless of linear or logarithmic tendencies.

In a preferred embodiment of the present invention, the above described means and methods for conducting in situ diagnostics is used by the control means to determine the allocation and division of power and/or feedstock available.

It is envisaged that means for the determination of available power are provided, as well as means for forecasting available power based on known conditions.

In the preferred embodiment, flow regulating means may also be provided on the inlet, upstream of the stack or stream thereof. This also includes embodiments comprising a feedstock outlet, such as electrolyser embodiments with an outlet for the electrolyte, the feedstock inlet and outlet forming loop comprising the feedstock inlet and outlet. A pump or equivalent being placed on the upstream of the stack or strings thereof to minimise the presence of dissolved gases.

In the preferred embodiment of strings of electrolysers, flow regulating means or otherwise pressure such as a check valves are placed on at least the hydrogen outlet.

In accordance with a second aspect of the present invention, there is provided a method of controlling a plurality of electrochemical devices in a containerised modular electrochemical system, said method comprising:
Providing a container, wherein the container is a housing, and
Providing a plurality of electrochemical stacks within said housing, wherein said electrochemical stacks are arranged into a series of strings, each string comprising at least one electrochemical stack, wherein:
   each electrochemical stack comprises at least one inlet and at least one outlet on each stack, and
flow regulating means are provided on at least one of the stack inlet(s) and/or outlet(s)Connecting a power source to each electrolytic stack or string thereof,
Providing computing means, wherein
   Said power source is controlled by said computing means, and
   said computing means is adapted to direct power to one or more strings, with means provided for the determining of power to be supplied, and
      The power supplied to the or each string may differ, and
Providing means for circulating feedstock.

In the preferred embodiment, the electrochemical system comprises primarily electrolyser stacks. Therefore, in accordance with the second aspect of the present invention there is provided a method of controlling a plurality of electrochemical devices in a containerised modular electrolyser system, said method comprising:
Providing a container, wherein the container is a housing, and
Providing a plurality of electrolysers within said housing, wherein said electrolysers are arranged into a series of strings, each string comprising at least one electrolyser, wherein
   each electrolyser comprises at least one inlet for an electrolyte and
   each electrolyser of string thereof comprises a at least one outlet for at least: generated hydrogen, generated oxygen and spent electrolyte, and
   flow regulating means are provided on at least one of the inlet(s) and/or outlet(s)
Connecting a power source to each electrolyser or string thereof,
Providing computing means, wherein
   Said power source is controlled by said computing means, and
   said computing means is adapted to direct power to one or more strings, with means provided for the determining of power to be supplied, and
      The power supplied to the or each string may differ, and
Providing means for circulating feedstock.

The method of operating the system as described above may be adapted to include any disclosed apparatus variant described above, including the utilisation of in-sit diagnostics, and other features.

The method may further comprise the step of providing means for controlling the outlet pressure from one or more outlet manifolds. Optionally, means may be provided for the purification of the contents of said outlet manifolds.

It is also envisaged that a walkway may be provided in the housing for access to each device. Said walkway may be provided centrally, but preferably rear access to each stack is also provided.

To help understanding of the invention, a specific embodiment thereof will now be described by way of example and with reference to the accompanying drawings, in which:

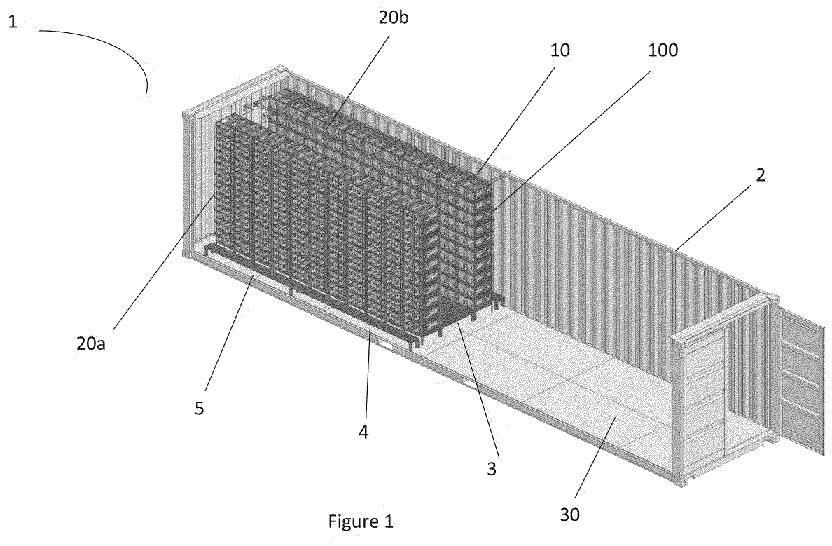

FIG. 1 is an example layout of a containerised electrochemical solution;

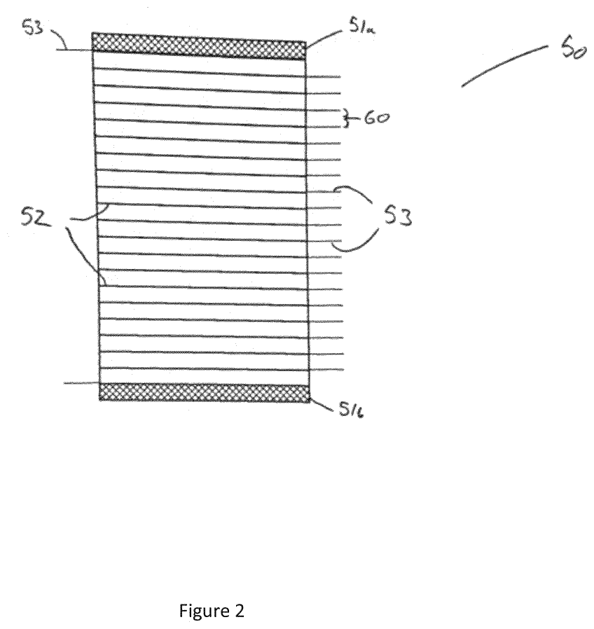

FIG. 2 is a schematic illustration of an example electrolytic stack;

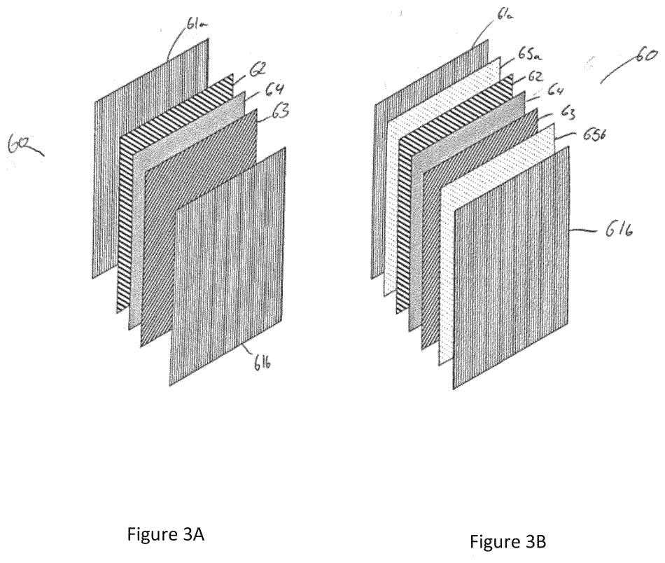

FIG. 3A and B illustrate schematically an example of a cell arrangement found in the stack depicted in FIG. 2;

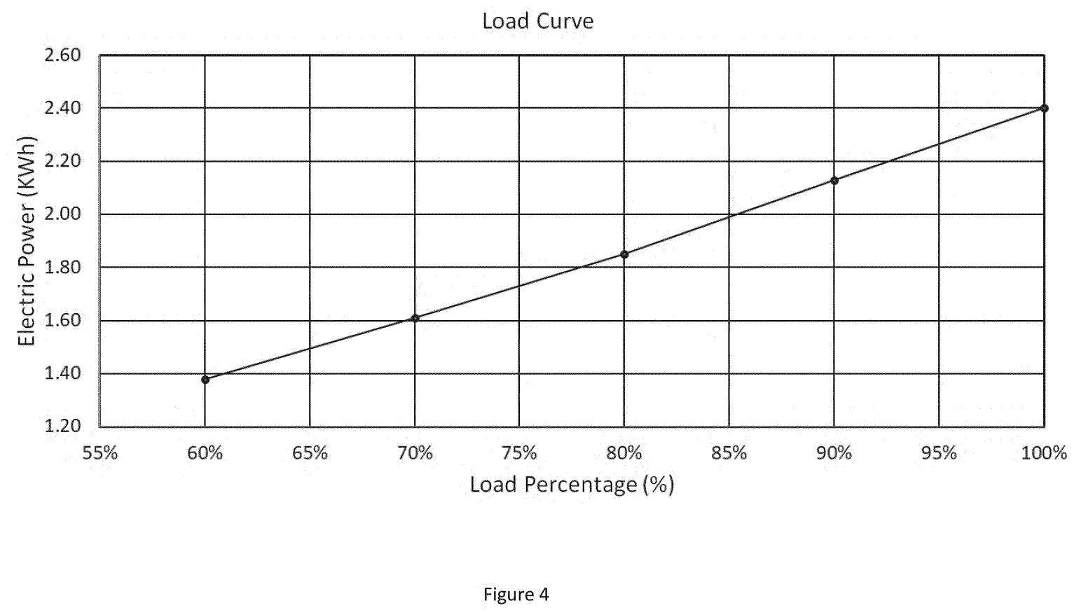

FIG. 4 is a load curve for a single stack;

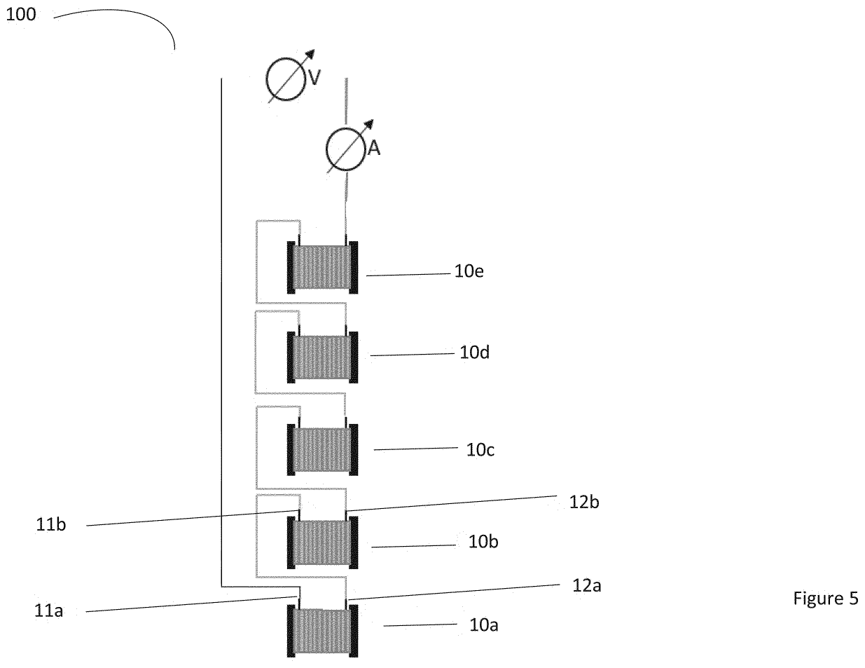

FIG. 5 depicts a string of stacks connected in series electrically;

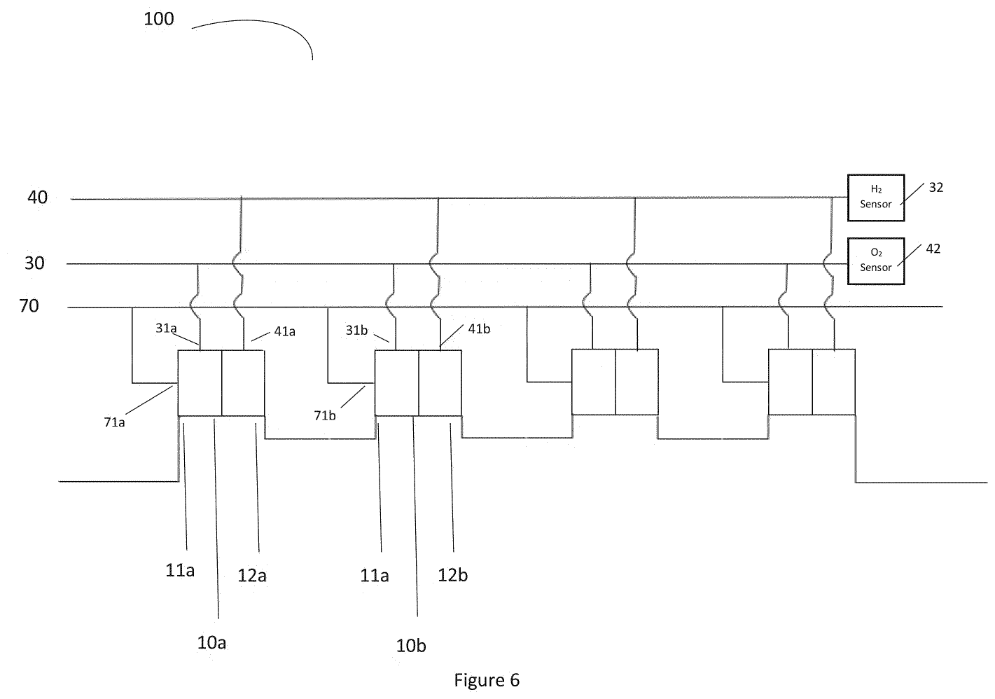

FIG. 6 depicts a string of stacks connected in series electrically and parallel fluidly;

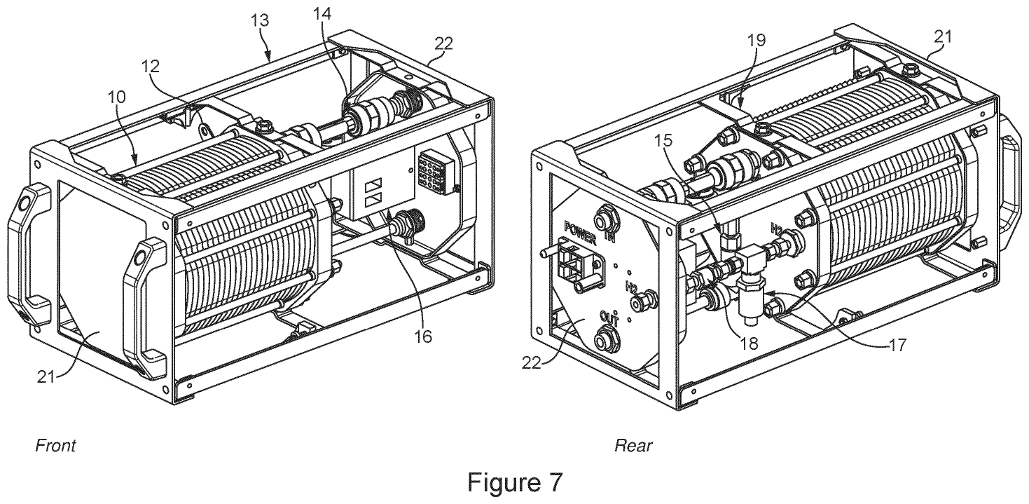

FIG. 7 shows a stack in a chassis from two aspects;

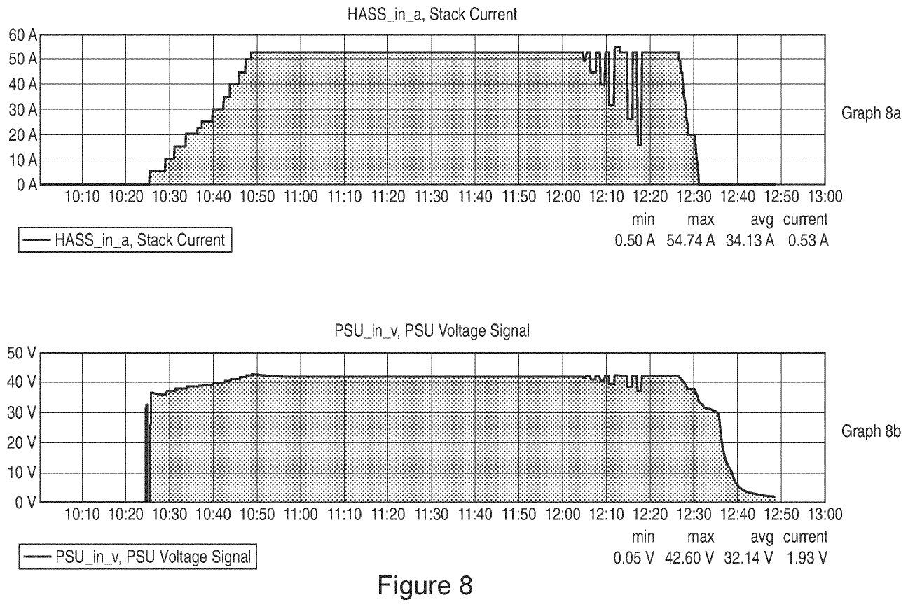

FIG. 8 depicts steady operation and load jumps for a string of 5 electrolysers (in graphs 8a and 8b); and

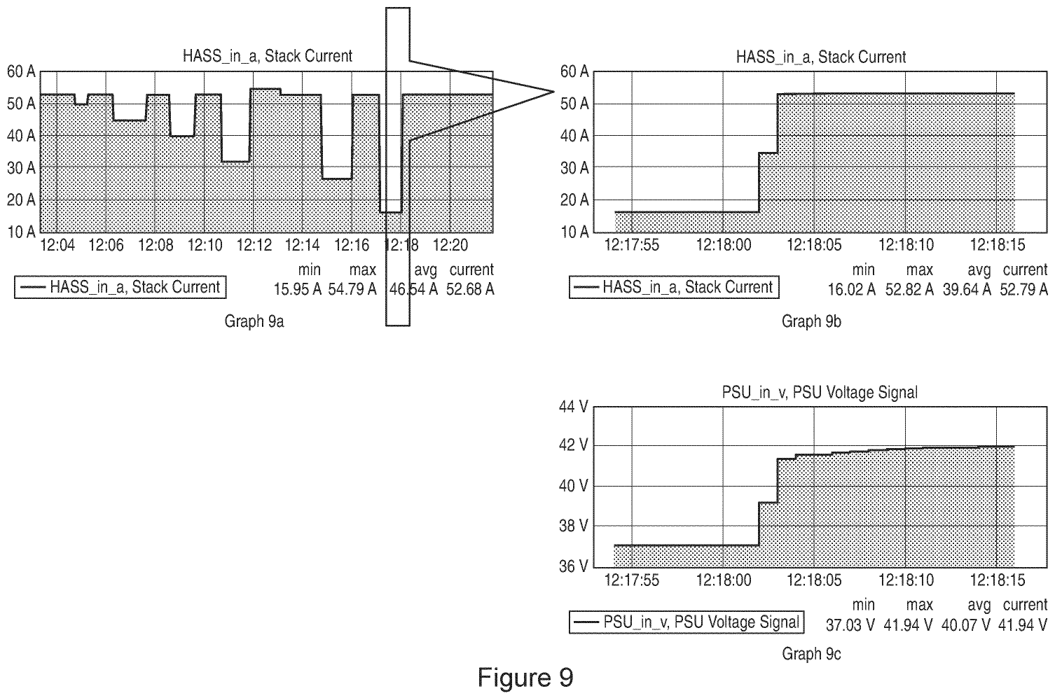

FIG. 9 depicts magnified load jump of a string of electrolysers (in graphs 9a-c).

### DETAILED DESCRIPTION

Referring to FIG. 1 a containerised modular electrochemical system 1 can be seen. The housing 2 is a standard shipping container with middle walkway 3 and rear walkways 4 the walkways 3 and 4 provide a clearance 5 for BoP (balance of plant) and drainage if necessary. Upon the walkway are modules 10, in this preferred embodiment the modules are electrolysers. The electrolysers 10 are arranged in columns 100, with said columns being strings sharing a power supply.

As discussed above, the walls 20a and 20b of devices do not need to be electrochemical devices of the same type.

The container 2 has area 30 for the BoP such as water tanks, pumps, hydrogen storage etc. all not shown. Also not shown are components such as means for ventilation, sensors and more.

Referring to FIG. 2 of the drawings, there is illustrated schematically an electrolytic stack 50, as could be used in the system 1 adapted for in-situ diagnostics. As can be seen, the stack is bordered by endplates 51a and 51b. Between said endplates are a plurality of cells 60, the composition of each may be seen in FIGS. 6A and 6B and described in more detail below. Bordering each cell 60 are bipolar plates 52. In order to conduct in-situ diagnostics as described above, the pins 53 are connected to the bipolar plates 52. The pins are connected to a stack board (not shown) to conduct the diagnostics, the results of which are communicated to the control/gateway and used for determining load distribution to each stack 50.

FIGS. 3A and 3B show schematically two examples of cells 60 which may be used in stack 50. Each type of cell 60 is bordered by a bipolar plate 61a and 61b. From the first bipolar plate 61a there is an anode 62, a membrane 64, a cathode 63 and the next bipolar plate 61b. In these figures the pins are not shown for the sake of clarity. The cell arrangement of FIG. 6B differs from that of FIG. 6A in that, between the bipolar plates 61a and the anode 62, there is a gas diffusion layer (GDL) 65a. Additionally, there is another GDL 65b between the cathode 63 and second bipolar plate 61b.

FIG. 4 is a graph depicting the load curve of an electrolytic stack depicted in arrangements illustrated in the aforementioned Figures. The load ranges from 60% to 100% as it is here the relationship is seen to be linear and arguably most efficient. Loads of over 100% are not done in order to protect the stack.

FIG. 5 depicts a string 100 of stacks 10a-e connected in series electrically. Power is supplied via a first connection 11a to the first stack 10a. Power is supplied from the first stack 10a to a second stack 10b via a wire connecting the second connection 12a of the first stack 10a to the first connection 11b of second stack 10b. This is repeated for each stack 10 in a string 100. For example power is supplied from the second stack 10b to the third stack 10c via a wire connecting the second connection 12b of the second stack to the third stack 10c, and so on.

FIG. 6 shows the string of FIG. 5 with parallel fluid connections. This includes an inlet manifold 70 carrying a feedstock to each stack 10 in the string 100. The inlet manifold 70 has an entrance to each stack via inlet 71a, 71b etc. In this embodiment the inlet is present on the cathodic half-cell of each electrolyser stack 10. An anodic outlet manifold 40 communicates generated oxygen from each anodic half-cell via outlet 41a, 41b etc. A second manifold outlet 30 is coupled to each cathodic half-cell for the communication of hydrogen out via outlets 31a, 31b etc.

Shown coupled to the string are sensors 32, and 42 for hydrogen and oxygen respectively. In order to ensure safety of outlets and ensure gases are not mixing above the lower explosive limit (LEL) the sensor for oxygen 32 may be placed on the hydrogen outlet manifold 30 and the hydrogen sensor 42 on the oxygen outlet manifold 40.

FIG. 7 shows a stack 10 in a chassis 13 from two aspects (front and rear). A connector pin 12 can be seen. Also shown between the rear of the stack 10 and the rear 22 of the chassis 12 are sensors such as flow meter 14, temperature sensor 15 electronics compartment 16 and pressure sensor 17. These may be operably connected to a control means wired or wirelessly. A check valve 18 is situated on the outlet. The front of the frame 21 has handles to allow the replacement of stacks as and when necessary for maintenance. Compression means discussed above are depicted as support brackets in this embodiment.

FIG. 8 depicts steady operation and load jumps for a string of 5 electrolysers as seen in other figures. Graph 8a shows time on the x axis and Amps on the Y axis. After initial ramp up steady and stable operation is shown between 10:50 and approximately 12:05. Between 12:05 and 12:30 load jumps are shown.

Graph 8b shows readings for the same setup with the Voltage being on the Y axis. Values must be multiplied by 5 due to the setup having 5 stacks, so a peak of approximately 210V is present. Surprisingly, the present configuration dampened the voltage swings allowing for more resilience in the system, a great benefit for a system coupled to inherently variable renewable energy sources.

FIG. 9 shows three graphs, 9a, 9b and 9c which are zoomed in versions of those seen in FIG. 8. The time in 9b and 9c is on a second scale instead of minutes. 9a shows which section is being highlighted. The step change is seen in both amp and voltage readings with no overshoot or oscillations. This allows for high speed tracking of variable energy availability which improves the efficacy of the system.

In the present figures not all BoP is shown, and the present invention is not necessarily intended to be limited by such BoP.

The invention is not intended to be restricted to the details of the above described embodiment. For instance, a single system may house a variety of electrochemical stacks such as electrolysers, compressors and fuel cell. Additionally, the BoP not claimed may also vary without departing from the scope of the present invention. The feedstock or electrolyte may also differ without departing from the scope of the present invention. It will be apparent to a person skilled in the art, from the foregoing description, that various modifications can be made to the described embodiments without departing from the scope of the invention as defined by the appended claims.

Listing of claims:

1. A containerised modular electrochemical cell system, comprising:
a housing; and
a plurality of electrochemical stacks removably mounted within said housing, each stack comprising: one or more electrochemical cells; one or more fluid inlet(s) for receiving feedstock; and one or more product outlet(s), wherein the stacks are arranged in at least one string, each string comprising two or more of the stacks, the stacks in each string being electrically connectable in series, and each string being connectable to a power source, and wherein each stack or string is configured to be independently activated; and
wherein each string comprises:
at least one feedstock inlet manifold fluidly coupled to the inlet(s) of the stacks of the string for distributing feedstock between the inlet(s) of the stacks, and at least one product outlet manifold fluidly coupled to the outlet(s) of the stacks of the string; and
flow regulation means configured to regulate fluid flow through the inlet(s) and/or outlet(s).

2. An electrochemical system as claimed in claim 1, further comprising feedstock delivery means configured to deliver quantities of feedstock to the inlet(s) dependent on available energy and/or power fluctuations, preferably wherein the feedstock delivery means is any one or more of pump, fan, or pressurised storage with regulated release.

3. (canceled)

4. An electrochemical system as claimed in claim 1, further comprising means for circulating spent electrolyte for reuse.

5. An electrochemical system as claimed in claim 1, wherein the electrochemical stacks constituting said strings comprise any one or more of:
electrolyser, compressor, purifiers, driers, and fuel cells.

6. An electrochemical system as claimed in claim 1, wherein the feedstock is any one or more of: electrolyte, gaseous stream comprising hydrogen and gaseous stream comprising oxygen, methanol, methane, carbon dioxide, carbon monoxide or DI water.

7. An electrochemical system as claimed in claim 1, wherein the electrochemical stacks comprise at least an anodic and cathodic half-cell, separated by a polymeric ion exchange membrane, preferably wherein the polymeric membrane is an AEM.

8. (canceled)

9. An electrochemical system as claimed in claim 1, wherein each string is supplied power, or supplies power with the power being supplied or provided to or by each stack in said string in series.

10. An electrochemical system as claimed in claim 1, wherein the housing is a standard shipping container.

11-12. (canceled)

13. An electrochemical system as claimed in claim 1, wherein means are provided to electrically and fluidly isolate each stack or string thereof to allow hot swapping of stacks, preferably wherein means are provided to isolate the stack or strings by manual means and or the computing means.

14. (canceled)

15. An electrochemical system as claimed in claim 1, wherein means are provided for thermal control.

16. An electrochemical system as claimed in claim 1, wherein the housing is provided with means for ventilation said ventilation means being activated when a potential leak is detected.

17. An electrochemical system as claimed in claim 1, wherein each stack or string is configured to be independently activated in dependence on available energy and/or power fluctuations.

18. An electrochemical system as claimed in claim 1, comprising means for independently activating each stack or string, preferably wherein the means for independently activating each stack or string is a computer-implemented power source control means for independently controlling the power supplied to each string of electrochemical cells, more preferably wherein the computer-implemented control means is operably connected to one or more sensors within the housing including any one or more of: leak detectors, pressure sensors, temperature sensors, humidity sensors, flowrate sensors, level sensors, pH sensors, conductivity sensors, oxygen sensors, hydrogen sensors, electrolyte sensor, gas sensors.

19-20. (canceled)

21. An electrochemical system as claimed in claim 1, wherein the system comprises one or more rectifiers to convert incoming power to allow supply of AC, DC or reverse pulse power.

22. An electrochemical system as claimed in claim 1, wherein means for in-situ diagnostics are provided on each stack or string thereof, preferably wherein the in-situ diagnostics is adapted to measure any one or more of:
cumulative run time of a stack or string thereof;
cumulative down time of a stack or string thereof;
operating capacity at which a stack or string thereof has been run at whilst running;
temperature of a stack or string thereof,
pressure of a stack or string thereof, and their associated inlets and or outlets,
voltage/potential of a stack or string thereof; and
data pertaining to the balance of plant such as but not limited to:
feedstock flow,
feedstock availability,
feedstock temperature
conductivity or equivalent parameter of feedstock
pump performance.

23. (canceled)

24. An electrochemical system as claimed in claim 22, wherein the in situ diagnostics are coupled to the computing means and used to determine power supply to or from the stack or string thereof, or feedstock availability of each stack or string thereof.

25. An electrochemical system as claimed in claim 1, wherein the system is adapted to do any one or more of: generate hydrogen and or oxygen; compress hydrogen and or oxygen; purify hydrogen and or oxygen; compress hydrogen and or oxygen.

26. An electrochemical system as claimed in claim 1, wherein the flow regulation means is configured to regulate fluid flow through the inlet(s) and/or outlet(s) by: selectively opening or closing the inlets and/or outlets; selectively opening or closing valves in the inlet or outlet manifolds; or restricting the fluid flow path through the inlets and/or outlets and/or through the inlet or outlet manifolds.

27. A containerised modular electrochemical system for the electrolytic production of hydrogen from water, said system comprising:
a housing
a plurality of electrochemical stacks removably within said housing, each stack comprising one or more electrolysers arranged into a series of strings, each string comprising at least one electrochemical stack, wherein each electrochemical stack comprises at least one inlet for an electrolyte and a plurality of outlets on each stack or string thereof for at least: generated hydrogen, generated oxygen and spent electrolyte,
flow regulating means provided on at least one of the stack inlet(s) and/or outlet(s)
a power source operably connected to each electrolytic stack or string thereof,
computer-implemented control means for controlling said power source and configured to direct power to one or more strings depending on an operating condition thereof; and
means for circulating spent electrolyte for reuse.

28. A method of controlling a plurality of electrochemical devices in a containerised modular electrochemical system, the method comprising:
providing a housing;
removably mounting a plurality of electrochemical stacks within said housing, such that said electrochemical stacks are arranged into a series of strings, each string comprising at least one electrochemical stack, wherein each stack comprises a fluid input for receiving feedstock and a product output and each string comprises a feedstock inlet fluidly coupled to the input(s) of the stack(s) thereof and at least one product outlet fluidly coupled to each of the output(s) of the stack(s) thereof;
operably connecting a power source to each string, wherein the stacks of each string are electrically connected in series;
causing feedstock to circulate between feedstock inlets;
providing low regulating means on at least one of the stack inlet(s) and/or outlet(s), said flow regulating means being configured to selectively open and close the respective inlet(s) and/or outlet(s); and
configuring a computer-implemented power source control means so as to independently control the power supplied to each string of electrochemical cells.

29. (canceled)
